(19) United States
(12) Patent Application Publication
(10) Pub. No.: US 2014/0005961 A1
(43) Pub. Date: Jan. 2, 2014

(54) OCCUPANCY SENSING

(71) Applicants: Arie Hod, Richmond Hill (CA); Valeri Wirt, Sudbury, MA (US)

(72) Inventors: Arie Hod, Richmond Hill (CA); Valeri Wirt, Sudbury, MA (US)

(73) Assignee: TCS International, Inc., Sudbury, MA (US)

(21) Appl. No.: 13/538,317

(22) Filed: Jun. 29, 2012

(51) Int. Cl. G01H 1/12; G06F 19/00

(52) U.S. Cl. 702/56

(57) ABSTRACT

A method includes transmitting a measurement-cycle ultrasonic signal from a signal transmitter toward a monitored space. Signals are received at a signal receiver. The signals include a sequence of measurement-cycle echo signals based on the transmitted measurement-cycle ultrasonic signal. Each measurement-cycle echo signal has associated signal strength. The method includes integrating data corresponding to the associated signal strengths for at least a portion of the sequence of measurement-cycle echo signals over time to produce an integrated measurement-cycle echo signal value. The method also includes comparing the integrated measurement-cycle echo signal value to an integrated calibration-cycle echo signal value that corresponds to the monitored space being empty.

### BACKGROUND

Systems are available that monitor the occupancy status of every parking space in a parking facility using ultrasonic sensors. In general, an ultrasonic sensor evaluates attributes of a target (e.g., a parking space) by interpreting the echoes from ultrasonic signals.

### SUMMARY OF THE INVENTION

In one aspect, a method is disclosed that includes transmitting a measurement-cycle ultrasonic signal from a signal transmitter toward a monitored space (e.g., a parking space for an automobile in a parking facility that has a plurality of parking spaces). Signals are received at a signal receiver. The signals include a sequence of measurement-cycle echo signals based on the transmitted measurement-cycle ultrasonic signal. Each measurement-cycle echo signal has associated signal strength. The method includes integrating data corresponding to the associated signal strengths for at least a portion of the sequence of measurement-cycle echo signals over time to produce an integrated measurement-cycle echo signal value. The method also includes comparing the integrated measurement-cycle echo signal value to an integrated calibration-cycle echo signal value that corresponds to the monitored space being empty.

In some implementations, the measurement-cycle ultrasonic signal is transmitted at an angle toward the monitored space (i.e., in a direction that is not perpendicular to a bottom surface of the monitored space on which an object, such as an automobile, can sit).

In some implementations, comparing the integrated measurement-cycle echo signal value to the integrated calibration-cycle echo signal value includes calculating a percent difference between the integrated measurement-cycle echo signal value and the integrated calibration-cycle echo signal value. Certain implementations include determining whether the space is empty or occupied based on whether the percent difference between the integrated measurement-cycle echo signal value and the integrated calibration-cycle echo signal value is greater than a threshold value. According to some implementation, the method includes confirming the determination with multiple subsequent determinations prior to providing an indication as to an outcome of the determination.

In a typical implementation, the method includes providing a human-detectable indication to as to an outcome of the determination. The human-detectable indication as to the outcome of the determination can include, for example, illuminating a visual indicator.

In some instances, the monitored space is a parking space for an automobile. In those instances, for example, the visual indicator may be arranged to provide illumination that is visible from a position that is displaced from the parking space and within a traffic lane that is adjacent to the parking space.

The method, in some implementations, includes establishing the integrated calibration-cycle echo signal value that corresponds to the monitored space being empty prior to transmitting the measurement-cycle ultrasonic signal. Establishing the integrated calibration-cycle echo signal value can include, for example, transmitting a calibration-cycle ultrasonic signal from the signal transmitter toward the monitored space when the monitored space is empty, receiving signals at the signal receiver, wherein the signals comprise a sequence of calibration-cycle echo signals based on the transmitted calibration-cycle ultrasonic signal, each calibration-cycle echo signal having an associated signal strength; and integrating data corresponding to the associated signal strengths for at least a portion of the sequence of calibration-cycle echo signals over time to produce the integrated calibration-cycle echo signal value.

In a typical implementation, the transmitter and the receiver are coupled to (e.g., mounted inside) a common housing. Moreover, in some implementations, a visual indicator is coupled to the common housing as well. The visual indicator can be generally operable to provide a visual indication as to whether the monitored space is empty or occupied. The common housing can be physically supported (e.g., suspended from a length of conduit) in such a manner that the signal transmitter transmits the measurement-cycle ultrasonic signal toward the monitored space at an angle (e.g., in a direction that is not perpendicular to a bottom surface of the monitored space on which an object can sit and not parallel to the bottom surface).

In some implementations, the method includes using a start index to identify a start point at which the signals being received at the signal receiver are considered to be relevant in determining whether the monitored space is empty or occupied and using an end index to identify an end point at which the signals being received at the signal receiver are considered to be not relevant in determining whether the monitored space is empty or occupied.

According to certain implementations, the method includes filtering at least a portion of the signals received at the signal receiver, wherein the filtered signals have respective signal strengths below a predefined threshold.

In another aspect, a method includes monitoring whether a plurality of parking spaces are empty or occupied using multiple monitoring devices. Monitoring the plurality of parking spaces comprises using each monitoring device to: transmit, from a signal transmitter, a measurement-cycle ultrasonic signal from a signal transmitter toward a corresponding one of the parking spaces; receive, at a signal receiver, signals that comprise a sequence of measurement-cycle echo signals based on the transmitted measurement-cycle ultrasonic signal, each measurement-cycle echo signal having an associated signal strength; integrate data corresponding to the associated signal strengths for at least a portion of the sequence of measurement-cycle echo signals over time to produce an integrated measurement-cycle echo signal value; and compare the integrated measurement-cycle echo signal value to an integrated calibration-cycle value that corresponds to the corresponding one of the parking spaces being empty.

The monitoring devices can, in some implementations, be synchronized with one another such that a corresponding measurement-cycle ultrasonic signal is transmitted from every one of the monitoring devices at substantially the same time.

Certain implementations can include providing a human-detectable indication from each respective one of the monitoring devices as to an outcome of a corresponding one of the determinations.

In some implementations, transmitting the measurement-cycle ultrasonic signal includes transmitting in a direction that is not perpendicular to a bottom surface of the parking space upon which an automobile can sit (and not parallel to the bottom surface). In those instances, the visual indicator is arranged to provide illumination that is visible from a position that is displaced from the parking space and within a traffic lane that is adjacent to the parking space.

Certain implementations include using each monitoring device to establish an associated one of the integrated calibration-cycle echo signal values prior to transmitting the measurement-cycle ultrasonic signals. Establishing the integrated calibration-cycle echo signal value can include, for example, having each one of the monitoring devices: transmit a calibration-cycle ultrasonic signal from the signal transmitter toward the parking space when the parking space is empty; receive signals at the signal receiver, where the signals include a sequence of calibration-cycle echo signals based on the transmitted calibration-cycle ultrasonic signal, each calibration-cycle echo signal having an associated signal strength; and integrate data corresponding to the associated signal strengths for at least a portion of the sequence of calibration-cycle echo signals over time to produce the integrated calibration-cycle echo signal value.

In another aspect, a monitoring device includes an ultrasonic transmitter configured to transmit a measurement-cycle ultrasonic signal from a signal transmitter toward a monitored space; an ultrasonic receiver configured to receive signals comprising a sequence of measurement-cycle echo signals based on the transmitted measurement-cycle ultrasonic signal, each measurement-cycle echo signal having an associated signal strength; and a processor configured to integrate data corresponding to the associated signal strengths for at least a portion of the sequence of measurement-cycle echo signals over time to produce an integrated measurement-cycle echo signal value and to compare the integrated measurement-cycle echo signal value to an integrated calibration-cycle echo signal value that corresponds to the monitored space being empty.

In some implementations, the processor is further configured to calculate a percent difference between the integrated measurement-cycle echo signal value and the integrated calibration-cycle echo signal value and to determine whether the space is empty or occupied based on whether the percent difference between the integrated measurement-cycle echo signal value and the integrated calibration-cycle echo signal value is greater than a threshold value. Moreover, in some implementations, the processor is configured to confirm the determination with multiple subsequent determinations prior to providing an indication as to an outcome of the determination.

Certain implementations include an outcome indicator configured to provide a human-detectable indication (e.g., a visual indicator, such as a light source) to indicate an outcome of the determination.

In some implementations, the ultrasonic transmitter is further configured to transmit a calibration-cycle ultrasonic signal from the signal transmitter toward the monitored space when the monitored space is empty. In those implementations, the ultrasonic receiver is configured to receive signals that include a sequence of calibration-cycle echo signals based on the transmitted calibration-cycle ultrasonic signal, each calibration-cycle echo signal having associated signal strength. Moreover, the processor is further configured to integrate data corresponding to the associated signal strengths for at least a portion of the sequence of calibration-cycle echo signals over time to produce the integrated calibration-cycle echo signal value.

The monitoring device, in certain implementations, further includes a memory storage unit configured to store the integrated calibration-cycle echo signal value.

The ultrasonic transmitter, the ultrasonic receiver and the processor can be coupled to (e.g., attached to and/or contained within) a common housing.

In yet another aspect, a system includes multiple monitoring devices at different positions in a parking facility. Each monitoring device is configured to monitor an associated one of the parking spaces in the parking facility. Moreover, each monitoring device includes: an ultrasonic transmitter configured to transmit a measurement-cycle ultrasonic signal from a signal transmitter toward a corresponding one of the monitored parking spaces; an ultrasonic receiver configured to receive signals comprising a sequence of measurement-cycle echo signals based on the transmitted measurement-cycle ultrasonic signal, each measurement-cycle echo signal having an associated signal strength; and a processor configured to integrate data corresponding to the associated signal strengths for at least a portion of the sequence of measurement-cycle echo signals over time to produce an integrated measurement-cycle echo signal value and to compare the integrated measurement-cycle echo signal value to an integrated calibration-cycle echo signal value that corresponds to the monitored space being empty.

In some implementations, the system is configured so that every one of the monitoring devices transmits a corresponding one of the measurement-cycle ultrasonic signals at substantially the same time.

According to certain implementations, each monitoring device in the system is configured to determine whether a corresponding one of the monitored parking space is empty or occupied based on the comparison and is configured to provide a human-detectable indication to as to an outcome of the determination. The human-detectable indication may be, for example, detectable from a position that is displaced from the parking space and within a traffic lane that is adjacent to the parking space.

In some implementations, each monitoring device in the system is configured so that the corresponding signal transmitter transmits the measurement-cycle ultrasonic signal toward the corresponding monitored space at an angle (i.e., in a direction that is not perpendicular to a bottom surface of the monitored space on which an object can sit and not parallel to the bottom surface).

In some implementations, one or more of the following advantages are present.

For example, highly accurate occupancy status determinations may be realized.

More particularly, highly accurate occupancy status determinations may be realized particularly where a monitoring device (that transmits and receives ultrasonic signals) is offset from the monitored parking space and, therefore, transmits the ultrasonic signals at an angle toward the monitored parking space. In those instances, resultant echo signals tend to scatter in a variety of directions with relatively few returning directly to the monitoring device (at least as compared to the echo signals that would return to the monitoring device if, for example, the monitoring device were positioned directly above where the automobile would park and transmitted the ultrasonic signal directly downward, for example).

Monitoring devices with built-in lights (e.g., green to indicate an empty space, red to indicate an occupied space) can be positioned offset from the monitored parking space. This so provides ease of visibility to a driver in a car that is driving, for example, along a traffic lane adjacent a row of monitored parking spaces.

Other features and advantages will be apparent from the description and drawings, and from the claims.

### BRIEF DESCRIPTION OF THE DRAWINGS

FIG. 1 is a plan view showing a portion of an exemplary parking facility for automobiles.

FIG. 2 is a flowchart showing an exemplary implementation of process performed by one of the monitoring devices in the parking facility of FIG. 1.

FIG. 3 is a graph that shows a distribution of signal strength density plotted against distance for an exemplary sequence of calibration-cycle echo signals.

FIG. 4 is a graph that shows a distribution of signal strength density plotted against distance for an exemplary sequence of measurement-cycle echo signals.

FIG. 5 is a perspective view of an exemplary monitoring device coupled to a conduit system.

FIG. 6 is an electrical schematic representation of an exemplary monitoring device.

FIG. 7 is an electrical schematic representation of an occupancy status monitoring system, such as the occupancy status monitoring system of FIG. 1.

Like reference numerals refer to like elements.

### DETAILED DESCRIPTION

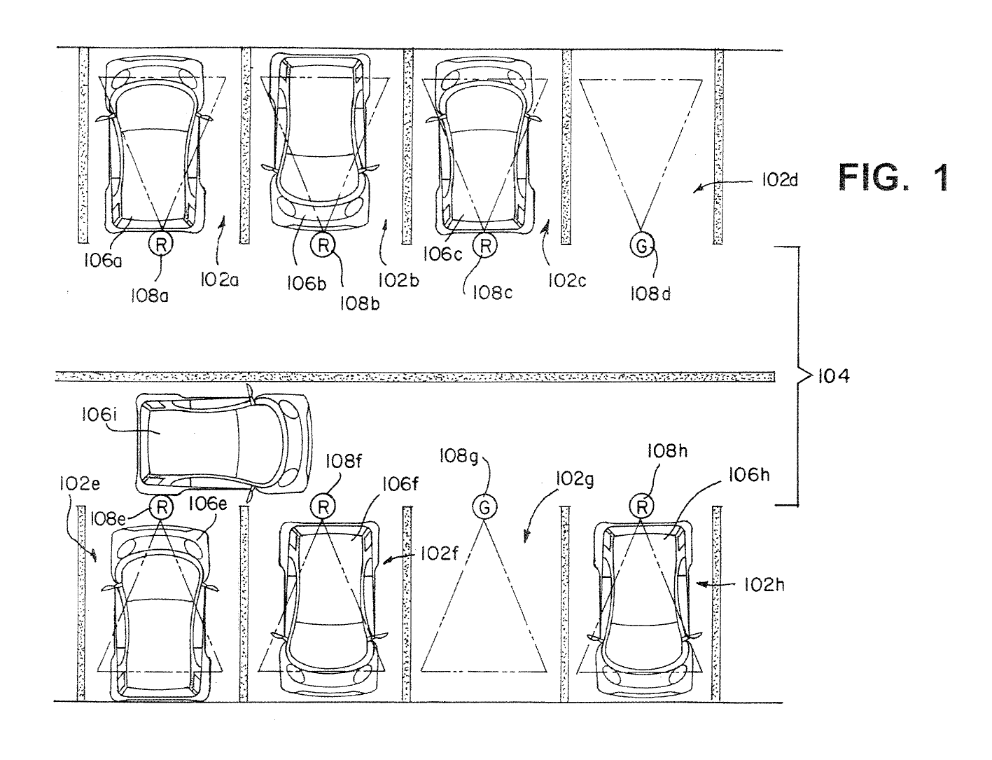

FIG. 1 is a plan view showing a portion of an exemplary parking facility 100 for automobiles.

The illustrated portion of the parking facility 100 has eight parking spaces 102a-102h and a bi-directional traffic lane 104 that provides access to the parking spaces 102a-102h. Four of the parking spaces 102a-102d are on one side of the bi-directional traffic lane 104 and four of the parking spaces 102e-102h are on an opposite side of the bi-directional traffic lane 104.

In the illustrated example, six of the parking spaces (i.e., 102a, 102b, 102c, 102e, 102f and 102h) are occupied by an automobile (106a, 106b, 106c, 106e, 106f and 106h) and two of the parking spaces (i.e., 102d and 102g) are empty. The parked automobiles (106a, 106b, 106c, 106e, 106f and 106h) are parked in a head-in configuration, side-by-side and substantially perpendicular to the directions of travel in the bi-directional traffic lane 104. Another automobile 106i is within the bi-directional traffic lane 104 and driving left-to-right in the illustrated example.

A monitoring device 108a-108h is provided next to each of the parking spaces 102a-102h, respectively. Each monitoring device 108a-108h is adapted to monitor the occupancy status (e.g., whether an automobile is parked there or not) of a corresponding one of the parking spaces. For example, monitoring device 108a is adapted to monitor the occupancy status of parking space 102a. Likewise, monitoring device 108b is adapted to monitor the occupancy status of parking space 102b.

In general, each monitoring device 108a-108h is adapted to provide an indication as to the occupancy status of its corresponding parking space 102a-102h. The indication can be any kind of indication that is detectable by a human. Examples include visual indications, audible indications and combined visual and audible indications. In the illustrated implementation, each monitoring device 108a-108h is adapted to provide an indication as to the occupancy status of its corresponding parking space 102a-102h by illuminating either a green light to indicate that its monitored parking space is empty or a red light to indicate that its monitored parking space is occupied. More particularly, in the illustrated example, monitoring devices 108d and 108g are illuminated with a green light to indicate that parking spaces

In a typical implementation, each monitoring devices 108a-108h is positioned above the traffic flow in the parking facility 100. For example, in some implementations, the monitoring devices 108a-108h are suspended from a conduit system that is hung off the parking facility's ceiling.

In general, each monitoring device 108a-108h is positioned so that it can provide an indication (e.g., a visual indication) of occupancy status that is detectable to an automobile driver at just about any point along the bi-directional traffic lane 104, even points that are displaced some distance from the particular monitored parking space in question. More particularly, in the illustrated implementation, each monitoring device 108a-108h is positioned near an outer edge of its corresponding monitored parking space. For example, monitoring device 108a is positioned near an outer edge of parking space 102a. Similarly, monitoring device 108g is positioned near an outer edge of parking space 102g. Therefore, the illumination emitted from these monitoring devices is easy to see from virtually anywhere along the length of the bi-directional traffic lane 104.

Thus, in the illustrated example, the driver in automobile 106i is able to see quite easily the red or green light being emitted from each of the monitoring devices 108a-108h along the sides of the bi-directional traffic lane 104. More particularly, the driver is able to see quite easily that monitoring devices 108d and 108g are green and the rest of the monitoring devices are red. Therefore, the driver can conclude, therefore, that the parking spaces 102d and 102g corresponding to the green lights on the monitoring devices 108d, 108g are empty. It is easy, therefore, for the driver to navigate quickly and safely to one of those empty parking spaces 102d and 102g to park.

In a typical implementation, the monitoring devices 108a-108h monitor the occupancy status of the parking spaces using ultrasonic technology. More particularly, each monitoring device 108a-108h is operable to transmit ultrasonic signals (represented schematically in FIG. 1 as cone) toward its monitored parking space 102a-102h. In general, the monitoring device 108a-108h evaluates attributes of its monitored parking space (e.g., whether the parking space is empty or occupied) by interpreting echo signals it receives from the transmitted ultrasonic signals.

Since the monitoring devices 108a-108h in the illustrated implementation are positioned near the outer edges of their corresponding monitored parking spaces 102a-102h, each monitoring devices 108a-108h is operable to transmit its ultrasonic signals at an angle that is offset from perpendicular relative to the floor directly below the monitoring device 108a-108h. That is, each monitoring device 108a-108h transmits its ultrasonic signal from above the traffic flow and near an outer edge of the monitored parking space 102a-102h toward a position in the parking space that would be occupied by an automobile parked there.

The angle at which a particular monitoring device will transmit its ultrasonic signal may depend somewhat on the geometry of the installation (e.g., the height of monitoring device above the floor, the size of the parking spot being monitored, how near or far from the outer edge of the parking space the monitoring device is located, etc.). However, in a typical implementation, the emitting angle is between 10 degrees and 50 degrees from perpendicular (e.g., between 20 degrees and 40 degrees from perpendicular or about 30 degrees from perpendicular).

Since the monitoring devices 108a-108h transmit the ultrasonic signals at an angle, rather than straight down for example, the transmitted ultrasonic signals tend to scatter in a variety of directions after contacting an object, such as an automobile or the floor of the parking facility, with relatively few echo signals returning to the monitoring device, even when the corresponding parking space is occupied.

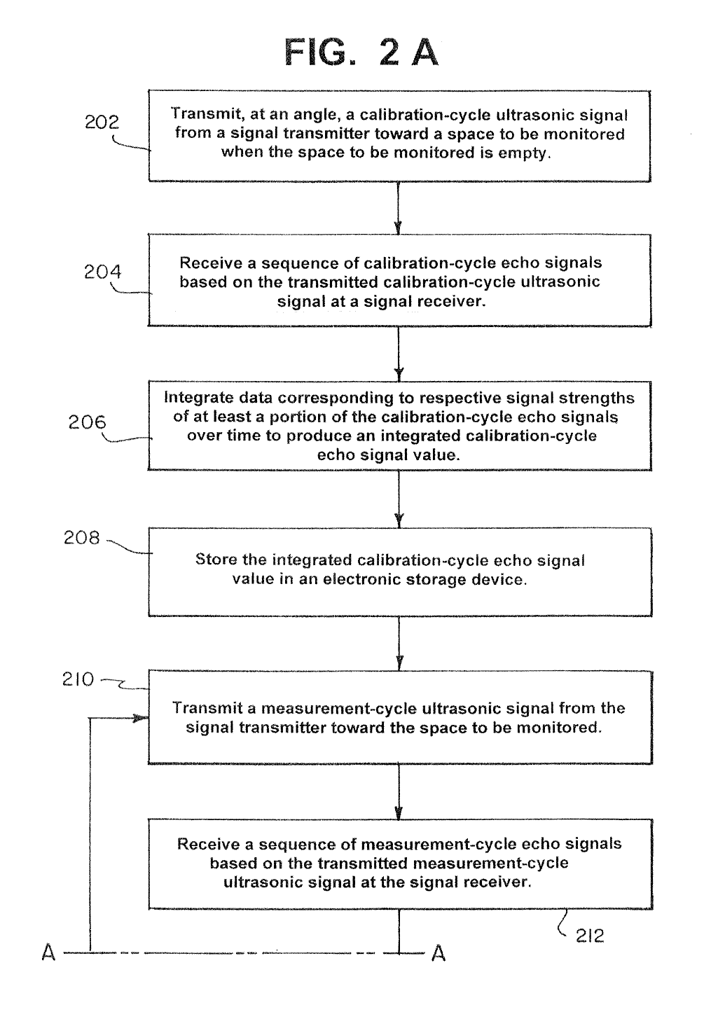

FIG. 2 is a flowchart showing an exemplary implementation of process performed by one of the monitoring devices 108a-108h in the parking facility 100 of FIG. 1.

Steps 202-208 in the illustrated method are steps in a calibration cycle for the monitoring device 108a. These steps 202-208 typically are performed only once during initial system start-up. However, these steps 202-208 may, in some instances, be performed subsequently to recalibrate an existing sensor or to calibrate a replacement sensor. In general, the calibration steps establish a baseline measurement (i.e., an integrated calibration-cycle echo signal value) that corresponds to the corresponding parking space (and all parking spaces in the parking facility 100) being empty.

Although the calibration steps 202-208 shown in the illustrated method are performed by a single monitoring device (e.g., 108a) in the system of FIG. 1, in a typical implementation, all of the monitoring devices 108a-108h in the system would be performing these steps at substantially the same time. Therefore, all of the monitoring devices 108a-108h become calibrated or recalibrated at substantially the same time.

The calibration process in steps 202-208 involve transmitting a calibration-cycle ultrasonic signal and receiving calibration-cycle echo signals that are based on the transmission. Since an ultrasonic transmission from one of the measurement devices 108a-108h may, in some instances, result in an echo signal being received at another one of the measurement devices 108a-108h, the transmission in the calibration steps 202-208 typically is conducted at every one of the measurement devices in a system at substantially the same time.

According to the illustrated process, the monitoring device 108a (at 202) transmits, at an angle, a calibration-cycle ultrasonic signal from its signal transmitter toward the parking space 102a when the parking space 102a is empty (i.e., there is no automobile in the parking space).

Typically, the transmitted ultrasonic signal travels through at least part of the monitored parking space, hits the floor, walls, support columns, etc. of the parking facility 100 resulting in echo signals, some of which end up travelling back to the monitoring device 108a.

According to the illustrated process, the monitoring device 108b (at 204) receives, at a signal receiver, a sequence of calibration-cycle echo signals based on the transmitted calibration-cycle ultrasonic signal. In a typical implementation, the signal transmitter and the signal receiver are the same device.

Due in part to the signal scattering that can occur by virtue of the ultrasonic signal being transmitted at an angle from the monitoring device 108a, the echo signals may be somewhat low in power when they reach the monitoring device 108a. Each echo signal's time of arrival at the monitoring device 108a relative to the transmission time represents a distance from the monitoring device 108a to whatever object reflected the ultrasonic signal to produce the echo signal.

In a typical implementation, the monitoring device 108a uses a start index to identify a start point at which the signal (e.g., the calibration signals) being received at the signal receiver is considered to be relevant for purposes of calibration. Additionally, the monitoring device 108a typically uses an end index to identify an end point at which the signals being received at the signal receiver are considered to be not relevant for purposes of calibration. The start index and the end index may be measured from the time that the ultrasonic signal is transmitted.

The monitoring device 108a also typically filters at least a portion of the signals being received at the signal receiver. In particular, the monitoring device 108a typically filters those signals that have signal strength below a predefined threshold value.

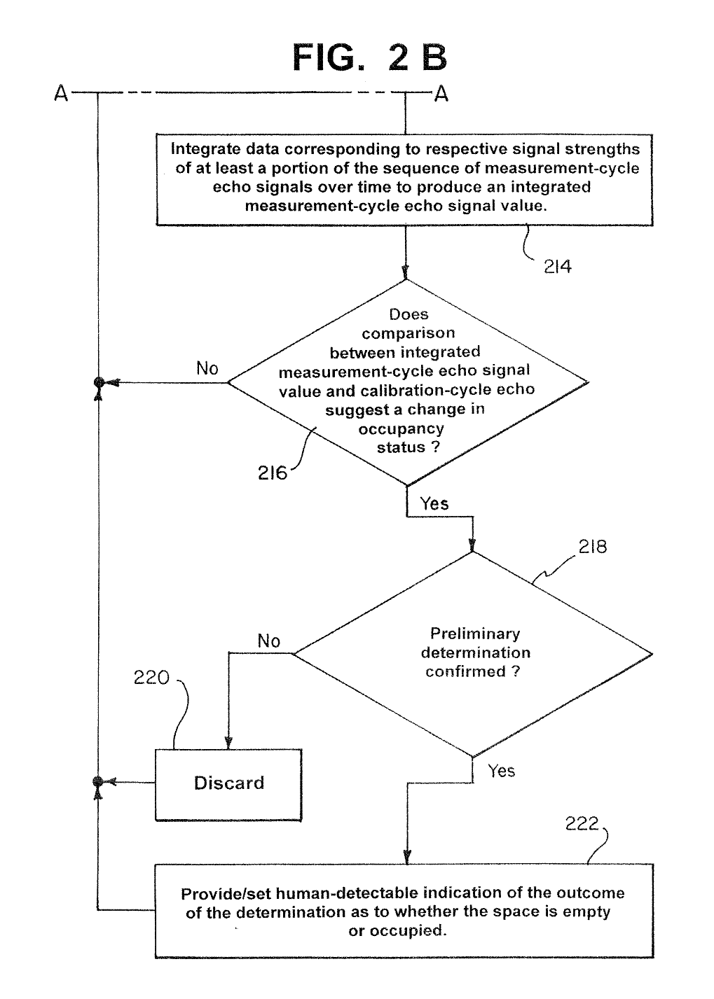

FIG. 3 is a graph that shows a distribution of signal strength density plotted against distance for an exemplary sequence of calibration-cycle echo signals.

In general, a distance (between the monitoring device and the reflecting object) can be associated with each respective echo signal based the amount of time that elapses between the transmission of the ultrasonic signal and the arrival of the respective echo signal at the monitoring device. In general, a single ultrasonic signal transmission can result in multiple echo signals returning to a monitoring device at different times because the transmitted ultrasonic signal hits multiple surfaces that return echo signals to the monitoring device and the multiple surfaces can be a different distances from the monitoring device.

The illustrated graph has a collection of relatively high density signals associated with a fairly narrow band of distances. This type of distribution is typical of echo signal data collected during a monitoring device calibration-cycle.

The illustrated graph also has a curve that approximates the signal strength associated with each distance.

Returning now to FIG. 2, the monitoring device 108a (at 206) integrates data corresponding to respective signal strengths of at least a portion of the calibration-cycle echo signals over time to produce an integrated calibration-cycle echo signal value.

In general, the term integration refers to a mathematical operation that involves approximating an area, such as the area under the curve shown in FIG. 3. This can include, for example, adding all of the values representing signal strength stored in the monitoring device's measurement array starting from the start index and ending at the end index (and excluding any filtered-out low strength signals). The integrated calibration-cycle echo signal value is a representation of this approximation. The integrated calibration-cycle echo signal can, in some implementations, have a value between 0 and 65535 bytes.

Next, the monitoring device 108a (at 208) stores the integrated calibration-cycle echo signal value in an electronic storage device, which may be incorporated in the monitoring device 108a itself.

Steps 210-224 in the illustrated method are steps in a measurement cycle for the monitoring device 108a. These steps 210-224 typically are repeated periodically during operation of the monitoring device 108a. In general, the measurement-cycle steps 210-224 check whether the signal strength profile of the echo signals changes from the baseline measurements obtained in the calibration cycle. If so, the monitoring device 108a provides a human-detectable indication (e.g., a visual illumination) of that change.

Although the measurement-cycle steps 210-224 shown in the illustrated method are performed by a single monitoring device (e.g., 108a) in the system of FIG. 1, in a typical implementation, all of the monitoring devices 108a-108h in the system would be performing many of these steps at substantially the same time. For example, the monitoring-cycle steps 210-224 involve transmitting a measurement-cycle ultrasonic signal and receiving measurement-cycle echo signals that are based on the transmission. In a typical implementation, all of the monitoring devices 108a-108h are synchronized so that they simultaneously transmit monitoring-cycle ultrasonic signals.

According to the illustrated process, the monitoring device 108a (at 210) transmits, at an angle, a measurement-cycle ultrasonic signal from its signal transmitter toward the parking space 102a.

Typically, the transmitted ultrasonic signal travels through at least part of the monitored parking space, hits the floor, walls, or support columns, etc. of the parking facility 100. Moreover, if there is an automobile present in the parking space, at least some portion of the transmitted signal hits the automobile. This results in echo signals, some of which end up travelling back to the monitoring device 108a.

According to the illustrated process, the monitoring device 108b (at 212) receives, at a signal receiver, a sequence of calibration-cycle echo signals based on the transmitted calibration-cycle ultrasonic signal. Data (e.g., data representing signal strength) associated with each of the calibration-cycle echo signals is may be stored by the monitoring device 108a in an array of 255 bytes, for example.

In a typical implementation, the monitoring device 108a uses a start index to identify a start point at which the signals (e.g., the measurement-cycle echo signals) being received at the signal receiver are considered to be relevant for purposes of measurement. Additionally, the monitoring device 108a typically uses an end index to identify an end point at which the signals being received at the signal receiver are considered to be not relevant for purposes of measurement. The start index and the end index may be measured from the time that the ultrasonic signal is transmitted.

The monitoring device 108a also typically filters at least a portion of the signals being received at the signal receiver. In particular, the monitoring device 108a typically filters those signals that have signal strength below a predefined threshold value.

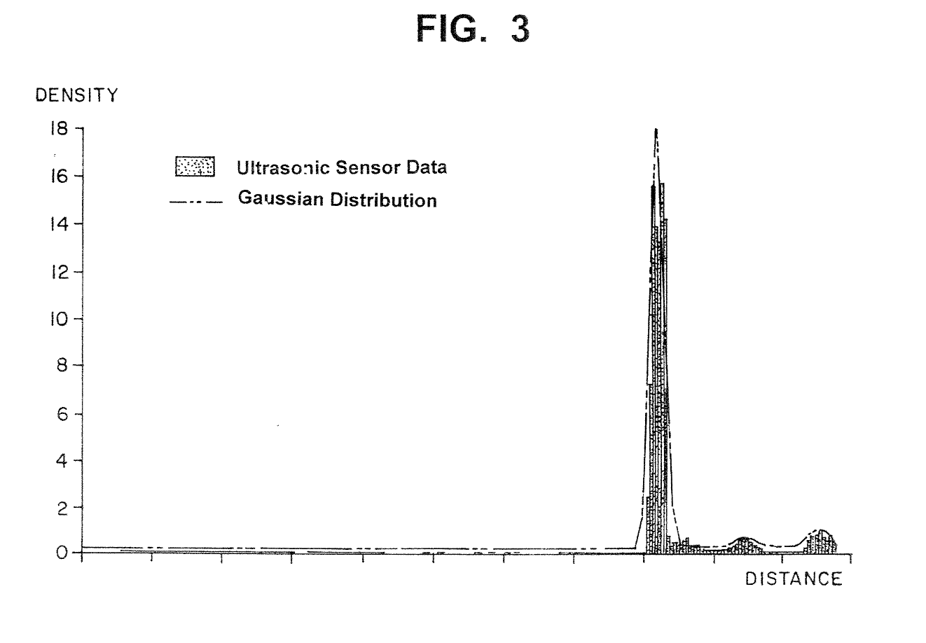

FIG. 4 is a graph that shows a distribution of signal strength density plotted against distance for an exemplary sequence of measurement-cycle echo signals.

In general, a distance (between the monitoring device and the reflecting object, such as an automobile) can be associated with each respective echo signal based the amount of time that elapses between the transmission of the ultrasonic signal and the arrival of the respective echo signal at the monitoring device. Moreover, a single ultrasonic signal transmission can result in multiple echo signals returning to a monitoring device at different times because the transmitted ultrasonic signal hits multiple surfaces that return echo signals to the monitoring device and the multiple surfaces can be a different distances from the monitoring device.

The illustrated graph has a collection of relatively high density signal strengths associated with a relatively broad band of distances. This type of distribution is typical of echo signal data collected during a monitoring device measurement-cycle.

The illustrated graph also has a curve that approximates the signal strength associated with each distance.

Returning now to FIG. 2, the monitoring device 108a (at 214) integrates data corresponding to respective signal strengths of at least a portion of the signals received (e.g., the measurement-cycle echo signals) over time to produce an integrated measurement-cycle echo signal value. Typically, the portion of signals received that are integrated over time exclude signals that were received prior to the start index and after the end index. Moreover, the portion of signals received that are integrated over time exclude any signals having signal strength low enough for the monitoring device to filter out.

In a typical implementation, integration involves approximating an area, such as the area under the curve shown in FIG. 4. This can include, for example, adding all of the values representing signal strength stored in the monitoring device's measurement array starting from the start index and ending at the end index (and excluding any filtered-out low strength signals). The integrated measurement-cycle echo signal value is a representation of this approximation. The integrated measurement-cycle echo signal can, in some implementations, have a value between 0 and 65535 bytes.

Next, the monitoring device 108a (at 216) compares the integrated measurement-cycle echo signal value to the stored integrated calibration-cycle echo signal value. In some implementations, this comparison can include, for example, calculating a percent difference between the integrated measurement-cycle echo signal value and the stored integrated calibration-cycle echo signal value.

If the comparison (at 216) suggests a change in occupancy status for the monitored parking space (e.g., from empty to occupied or vice versa), then the monitoring device 108a preliminarily determines that a change has occurred (e.g., a previously empty space has become occupied or a previously occupied space has become empty). In general, if the integrated measurement-cycle echo signal value is the same as or substantially close to (e.g., with 5%, 10% or 20%) the stored the integrated calibration-cycle echo signal value, then the monitoring device 108a makes a preliminary determination that the monitored parking space is empty. If, on the other hand, there is a meaningful difference between the integrated measurement-cycle echo signal value and the stored integrated calibration-cycle echo signal value, then the monitoring device 108a makes a preliminary determination that the monitored parking space is occupied. In general, for a difference to be considered meaningful, it should be large enough to exclude differences that may occur when something other than an automobile (e.g., a person, a shopping cart, etc.) is in the monitored parking space. In some implementations, for a difference to be considered to be meaningful, the difference needs to be greater than a predefined threshold (e.g., 5%, 10%, 20%, etc.).

If the comparison (at 216) suggests a change in occupancy status and the monitoring device 108a has made a preliminary determination as to the new occupancy status, then the monitoring device 108a attempts (at 218) to confirm its preliminary determination. This confirmation typically involves cycling through a series of steps (that include steps 210 through 216 in FIG. 2) a number of times. In some implementations, the monitoring device 108a is able to repeat these steps up to as many as 100 times (e.g., 30 times) in an attempt to confirm the preliminary determination.

Typically, if any of the confirmatory cycles (of steps 210 through 216) produces an outcome that is different than the monitoring device's preliminary determination, then the preliminary determination is not confirmed. However, if all of the confirmatory cycles (of steps 210 through 216) match the preliminary determination, then the preliminary determination is confirmed.

If the monitoring device (at 218) does not confirm the preliminary determination, then the monitoring device 108a (at 220) discards the preliminary determination and the monitoring device 108a returns to step 210 in FIG. 2.

If, however, the preliminary determination is confirmed (at 220), then the monitoring device 108a (at 222) provides a human-detectable indication of the confirmed determination. This can include, for example, illuminating a red light (that represents an occupied parking space) at the monitoring device 108a and extinguishing a green light (representing an empty parking space) at the monitoring device 108a.

If the comparison (at 216) does suggest a change in occupancy status, then the monitoring device 108a returns to step 210 in the illustrated process. In a typical implementation, a single measurement cycle (e.g., one cycle that includes steps 210 through 216 in FIG. 2) has a minimum duration of 120 micro-seconds.

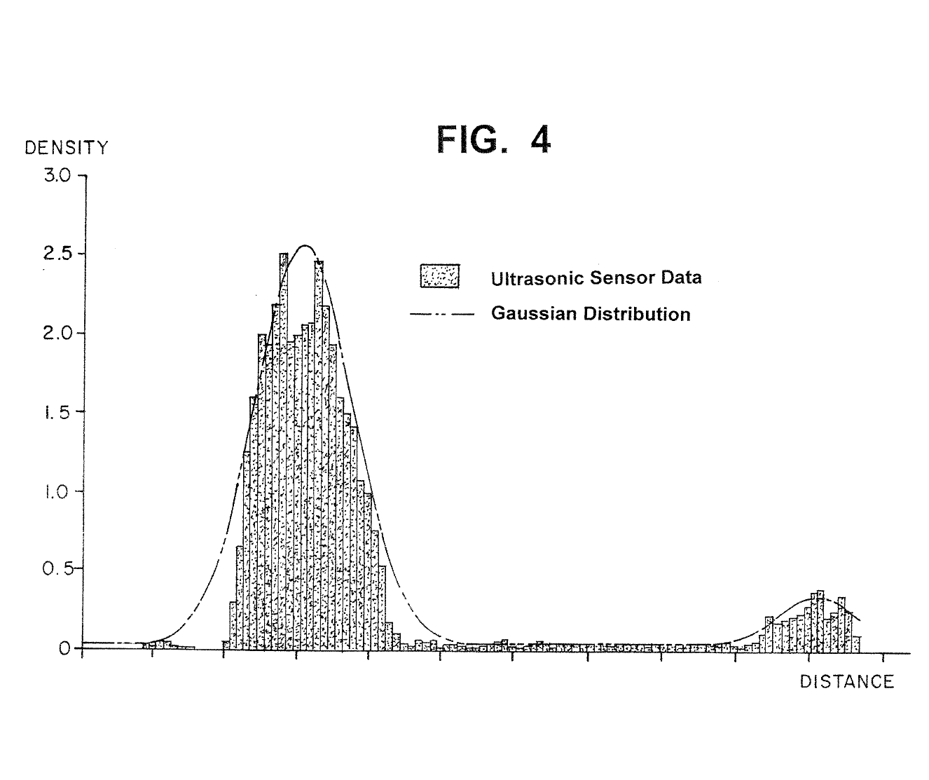

FIG. 5 is a perspective view of an exemplary monitoring device (i.e., monitoring device 108a) coupled to a conduit system 520.

The illustrated monitoring device 108a has a substantially flat base member 524 and an at least partially translucent, substantially dome-shaped member 526 coupled to the base. The base member 524 is coupled to a lower end of a vertically-disposed conduit member 522a.

A pair of ultrasonic transceivers 528 is exposed at an outer surface of the monitoring device 108a. In a typical implementation, each ultrasonic transceiver 528 is operable as both an ultrasonic transmitter and an ultrasonic receiver. Each ultrasonic transceiver 528 is angled relative to vertical and angled relative to horizontal so that when the monitoring device 108a is coupled to the lower end of a vertically-disposed conduit member (such as shown in FIG. 5) and the monitoring device 108a is installed above and near an end of a monitored parking space (such as shown in FIG. 1), then the ultrasonic transceivers 528 can transmit a signal downward and into the monitored space.

The illustrated monitoring device 108a also has one or more lights that are covered by the at least partially translucent member 526 (and are not visible in FIG. 5a). Illumination from the lights is generally detectable through the at least partially translucent member 526.

In a typical implementation, the monitoring device 108a includes at least two lights (e.g., one green light to indicate that the monitored parking space is empty and one red light to indicate that the monitored parking space is occupied). However, other implementations may include more than or less than two lights. For example, some implementations may include only one light (e.g., illumination means that the monitored parking space is empty and no illumination means that the monitored parking space is occupied). Additionally, some implementations include one or more additional lights. For example, an additional blue may be included to indicated that the monitored parking space is empty but is designated for some special use (e.g., for drivers having certain disabilities, for diplomats only, etc.).

The vertically-disposed conduit member 522a in the illustrated implementation is connected to a junction box 530, which is itself connected to two horizontally-disposed conduit members 522b, 522c. In some implementations, the junction box 530 and the conduit members 522a, 522b, 522c carry system power and signal wires for the illustrated monitoring device 108a and for other monitoring devices in the system.

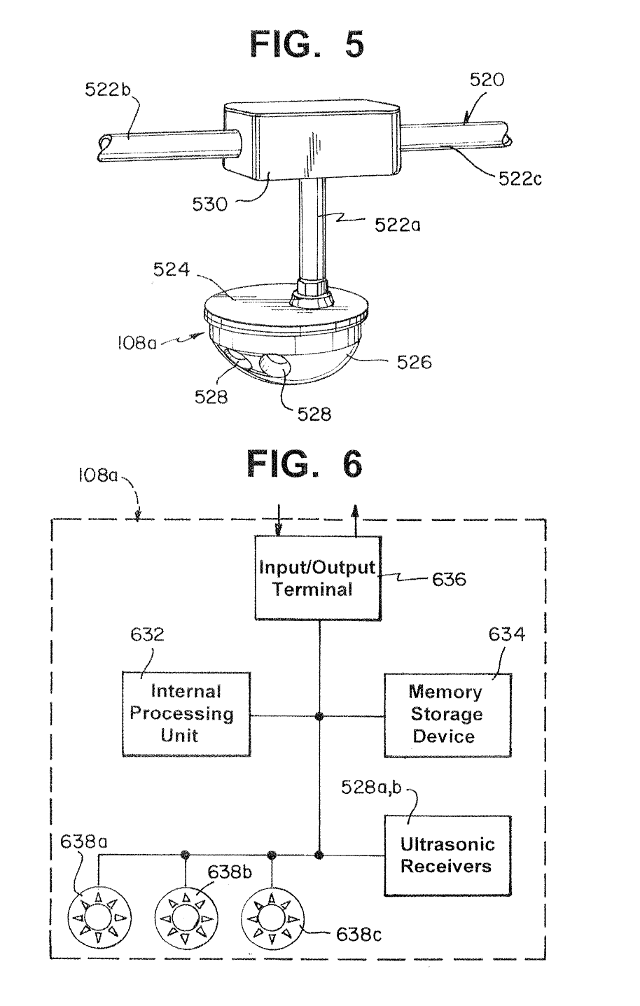

FIG. 6 is an electrical schematic representation of an exemplary monitoring device (i.e., monitoring device 108a).

According to the schematic representation, the monitoring device 108a has an internal processing unit 632 and memory storage device 634. In general, the processing unit 632 and memory storage device 634 are operable to implement and/or facilitate the logic and functionality associated with monitoring device 108a described herein.

The monitoring device 108a also has an input/output terminal 636 that facilitates communications, including the transfer of data, software, etc. between the monitoring device 108a and other external components, such as a remotely-located controller and/or other monitoring devices in the system.

The monitoring device 108a also includes three lights 638a (green), 638b (red), 638c (blue) and a pair of ultrasonic transceivers 528a, 528b.

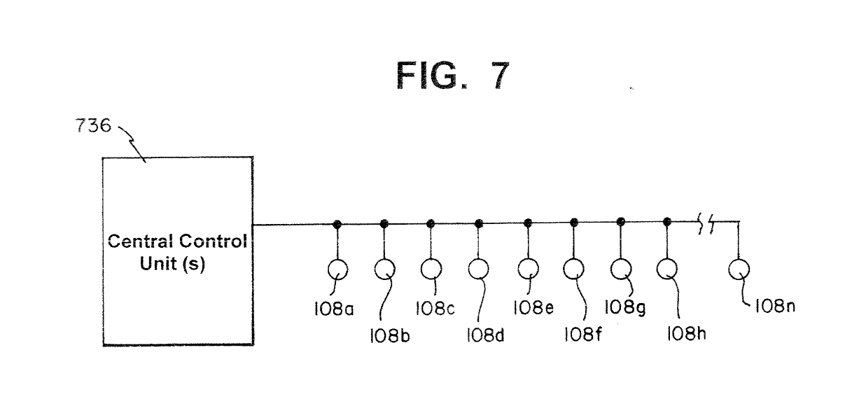

FIG. 7 is an electrical schematic representation of an occupancy status monitoring system, such as the occupancy status monitoring system of FIG. 1.

The illustrated system includes multiple monitoring devices 108a-108n electrically coupled to a central control unit 736. The electrical coupling may be implemented in a number of ways including, for example, by use of hard wiring, or a wireless connection.

In various implementations, the control unit 736 is adapted to perform various monitoring and/control functionality associated with the system.

For example, in some implementations, the control unit 736 broadcasts a triggering signal to all of the monitoring units in the system to initiate either a calibration cycle or a measurement cycle. Therefore, all of the monitoring units are substantially synchronized with each other. Also, in some implementations, the control unit 736 may be operable to perform calculations and processing associated with one or more of the processes disclosed herein.

A number of implementations of the invention have been described. Nevertheless, it will be understood that various modifications may be made without departing from the spirit and scope of the invention.

For example, one or more monitoring devices may be provided with an additional light or lights to indicated other factors having to do with the availability of a monitored parking space for parking (e.g., whether the parking space is reserved for a particular party, etc.)

Additionally, the order of process steps described herein can change. In certain instances, some of the steps may be omitted and/or additional steps may be added. Various steps and processes described may be distributed across additional system components (e.g., remotely-located memory devices and/or processes) that are not physically part of the monitoring device.

The control unit may include multiple units that are physically separate from one another.

Moreover, the devices, systems, techniques, etc. described herein may be applicable to monitor other spaces beyond just parking spaces for automobiles.

Accordingly, other implementations are within the scope of the claims.

What is claimed is:

1. A method comprising:
transmitting a measurement-cycle ultrasonic signal from a signal transmitter toward a monitored space;
receiving signals at a signal receiver, wherein the signals comprise a sequence of measurement-cycle echo signals based on the transmitted measurement-cycle ultrasonic signal, each measurement-cycle echo signal having an associated signal strength;
integrating data corresponding to the associated signal strengths for at least a portion of the sequence of measurement-cycle echo signals over time to produce an integrated measurement-cycle echo signal value; and
comparing the integrated measurement-cycle echo signal value to an integrated calibration-cycle echo signal value that corresponds to the monitored space being empty.

2. The method of claim 1 wherein comparing the integrated measurement-cycle echo signal value to the integrated calibration-cycle echo signal value comprises:
calculating a percent difference between the integrated measurement-cycle echo signal value and the integrated calibration-cycle echo signal value.

3. The method of claim 2 further comprising:
determining whether the space is empty or occupied based on whether the percent difference between the integrated measurement-cycle echo signal value and the integrated calibration-cycle echo signal value is greater than a threshold value.

4. The method of claim 3 further comprising:
confirming the determination with multiple subsequent determinations prior to providing an indication as to an outcome of the determination.

5. The method of claim 3 further comprising providing a human-detectable indication to as to an outcome of the determination.

6. The method of claim 5 wherein providing the human-detectable indication as to the outcome of the determination comprises illuminating a visual indicator.

7. The method of claim 5 wherein the monitored space is a parking space for an automobile, and
wherein the visual indicator is arranged to provide illumination that is visible from a position that is displaced from the parking space and within a traffic lane that is adjacent to the parking space.

8. The method of claim 1 further comprising establishing the integrated calibration-cycle echo signal value that corresponds to the monitored space being empty prior to transmitting the measurement-cycle ultrasonic signal.

9. The method of claim 8 wherein establishing the integrated calibration-cycle echo signal value comprises:
transmitting a calibration-cycle ultrasonic signal from the signal transmitter toward the monitored space when the monitored space is empty;
receiving signals at the signal receiver, wherein the signals comprise a sequence of calibration-cycle echo signals based on the transmitted calibration-cycle ultrasonic signal, each calibration-cycle echo signal having an associated signal strength; and
integrating data corresponding to the associated signal strengths for at least a portion of the sequence of calibration-cycle echo signals over time to produce the integrated calibration-cycle echo signal value.

10. The method of claim 1 wherein the transmitter and the receiver are coupled to a common housing.

11. The method of claim 10 wherein a visual indicator is coupled to the common housing,
wherein the visual indicator is operable to provide a visual indication as to whether the monitored space is empty or occupied.

12. The method of claim 10 wherein the common housing is physically supported in such a manner that the signal transmitter transmits the measurement-cycle ultrasonic signal toward the monitored space in a direction that is not perpendicular to a bottom surface of the monitored space on which an object can sit.

13. The method of claim 1 further comprising:
using a start index to identify a start point at which the signals being received at the signal receiver are considered to be relevant in determining whether the monitored space is empty or occupied; and
using an end index to identify an end point at which the signals being received at the signal receiver are considered to be not relevant in determining whether the monitored space is empty or occupied.

14. The method of claim 1 further comprising:
filtering at least a portion of the signals received at the signal receiver, wherein the filtered signals have respective signal strengths below a predefined threshold.

15. The method of claim 1 wherein the monitored space is a parking space for an automobile in a parking facility that has a plurality of parking spaces.

16. A method comprising:
monitoring whether a plurality of parking spaces are empty or occupied using a plurality of monitoring devices,
wherein monitoring the plurality of parking spaces comprises using each monitoring device to:
transmit, from a signal transmitter, a measurement-cycle ultrasonic signal from a signal transmitter toward a corresponding one of the parking spaces;
receive, at a signal receiver, signals that comprise a sequence of measurement-cycle echo signals based on the transmitted measurement-cycle ultrasonic signal, each measurement-cycle echo signal having an associated signal strength;
integrate data corresponding to the associated signal strengths for at least a portion of the sequence of measurement-cycle echo signals over time to produce an integrated measurement-cycle echo signal value; and
compare the integrated measurement-cycle echo signal value to an integrated calibration-cycle value that corresponds to the corresponding one of the parking spaces being empty.

17. The method of claim 16 wherein the plurality of monitoring devices are synchronized with one another such that a corresponding measurement-cycle ultrasonic signal is transmitted from every one of the monitoring devices at substantially the same time.

18. The method of claim 16 further comprising providing a human-detectable indication from each respective one of the monitoring devices as to an outcome of a corresponding one of the determinations.

19. The method of claim 16 wherein transmitting the measurement-cycle ultrasonic signal comprises transmitting in a direction that is not perpendicular to a bottom surface of the parking space upon which an automobile can sit, and wherein the visual indicator is arranged to provide illumination that is visible from a position that is displaced from the parking space and within a traffic lane that is adjacent to the parking space.

20. The method of claim 1 further comprising using each monitoring device to establish an associated one of the integrated calibration-cycle echo signal values prior to transmitting the measurement-cycle ultrasonic signals, wherein establishing the integrated calibration-cycle echo signal values comprise having each one of the monitoring devices:
transmit a calibration-cycle ultrasonic signal from the signal transmitter toward the parking space when the parking space is empty;
receive signals at the signal receiver, wherein the signals comprise a sequence of calibration-cycle echo signals based on the transmitted calibration-cycle ultrasonic signal, each calibration-cycle echo signal having an associated signal strength; and
integrate data corresponding to the associated signal strengths for at least a portion of the sequence of calibration-cycle echo signals over time to produce the integrated calibration-cycle echo signal value.

21. A monitoring device comprising:
an ultrasonic transmitter configured to transmit a measurement-cycle ultrasonic signal from a signal transmitter toward a monitored space;
an ultrasonic receiver configured to receive signals comprising a sequence of measurement-cycle echo signals based on the transmitted measurement-cycle ultrasonic signal, each measurement-cycle echo signal having an associated signal strength; and
a processor configured to integrate data corresponding to the associated signal strengths for at least a portion of the sequence of measurement-cycle echo signals over time to produce an integrated measurement-cycle echo signal value and to compare the integrated measurement-cycle echo signal value to an integrated calibration-cycle echo signal value that corresponds to the monitored space being empty.

22. The monitoring device of claim 21 wherein the processor is further configured to calculate a percent difference between the integrated measurement-cycle echo signal value and the integrated calibration-cycle echo signal value and to determine whether the space is empty or occupied based on whether the percent difference between the integrated measurement-cycle echo signal value and the integrated calibration-cycle echo signal value is greater than a threshold value.

23. The monitoring device of claim 22 wherein the processor is configured to confirm the determination with multiple subsequent determinations prior to providing an indication as to an outcome of the determination.

24. The monitoring device of claim 22 further comprising an outcome indicator configured to provide a human-detectable indication to indicate an outcome of the determination.

25. The monitoring device of claim 24 wherein the outcome indicator comprises a visual indicator.

26. The monitoring device of claim 21 wherein the ultrasonic transmitter is further configured to transmit a calibration-cycle ultrasonic signal from the signal transmitter toward the monitored space when the monitored space is empty,
wherein the ultrasonic receiver is further configured to receive signals that comprise a sequence of calibration-cycle echo signals based on the transmitted calibration-cycle ultrasonic signal, each calibration-cycle echo signal having an associated signal strength; and
wherein the processor is further configured to integrate data corresponding to the associated signal strengths for at least a portion of the sequence of calibration-cycle echo signals over time to produce the integrated calibration-cycle echo signal value.

27. The monitoring device of claim 26 further comprising:
a memory storage unit configured to store the integrated calibration-cycle echo signal value.

28. The monitoring device of claim 21 wherein the ultrasonic transmitter, the ultrasonic receiver and the processor are coupled to a common housing.

29. A system comprising:
a plurality of monitoring devices at different positions in a parking facility, wherein each monitoring device is configured to monitor an associated one of a plurality of parking spaces in the parking facility and comprises:
an ultrasonic transmitter configured to transmit a measurement-cycle ultrasonic signal from a signal transmitter toward a corresponding one of the monitored parking spaces;
an ultrasonic receiver configured to receive signals comprising a sequence of measurement-cycle echo signals based on the transmitted measurement-cycle ultrasonic signal, each measurement-cycle echo signal having an associated signal strength; and
a processor configured to integrate data corresponding to the associated signal strengths for at least a portion of the sequence of measurement-cycle echo signals over time to produce an integrated measurement-cycle echo signal value and to compare the integrated measurement-cycle echo signal value to an integrated calibration-cycle echo signal value that corresponds to the monitored space being empty,
wherein every one of the monitoring devices is configured to transmit a corresponding one of the measurement-cycle ultrasonic signals at substantially the same time.

30. The system of 29 wherein each one of the plurality of monitoring devices is configured to determine whether the corresponding one of the monitored parking space is empty or occupied based on the comparison and is configured to provide a human-detectable indication to as to an outcome of the determination,
wherein the human-detectable indication is detectable from a position that is displaced from the parking space and within a traffic lane that is adjacent to the parking space.

31. The system of claim 29 wherein each one of the plurality of monitoring devices is configured so that the corresponding signal transmitter transmits the measurement-cycle ultrasonic signal toward the corresponding monitored space in a direction that is not perpendicular to a bottom surface of the monitored space on which an object can sit.
